(19) United States
(12) Patent Application Publication
(10) Pub. No.: US 2007/0125417 A1
(43) Pub. Date: Jun. 7, 2007

(54) SOLAR ENERGY SYSTEM FOR HYBRID VEHICLES

(75) Inventors: James Gregory Johanson, Westlake Village, CA (US); Mark Bagnall, Monument, CO (US)

Correspondence Address: KELLY LOWRY & KELLEY, LLP, 6320 CANOGA AVENUE, SUITE 1650, WOODLAND HILLS, CA, 91367, US

(73) Assignee: SOLAR ELECTRICAL VEHICLE, INC., Westlake Village, CA (US)

(21) Appl. No.: 11/608,148

(22) Filed: Dec. 7, 2006

Related U.S. Application Data
(60) Provisional application No. 60/597,517, filed on Dec. 7, 2005.

(51) Int. Cl. H02N 6/00

(52) U.S. Cl. 136/244; 136/291

(57) ABSTRACT

A solar energy system for a hybrid vehicle that utilizes an attachable solar panel to receive and convert solar energy into direct current electricity. A wiring harness directs the direct current electricity generated by the solar panel to a converter. The converter transforms the direct current electricity from a comparatively lower energy state to a comparatively higher energy state.

### BACKGROUND OF THE INVENTION

The present invention is generally directed a solar energy system. More particularly, the present invention relates to a solar energy system for incorporation into hybrid vehicles as a supplemental power source.

A hybrid vehicle or gas-electric hybrid powered vehicle uses a mixture of technologies such as internal combustion engines (ICES), electric motors, gasoline, and batteries. Such vehicles supplement, or at times even replace, the power generated from the gasoline internal combustion engine with electric power, such as that stored in the batteries. Electricity within the batteries can come from several sources, including: generators coupled to the combustion engine or electricity derived from moving parts of the vehicle, such as the wheels.

The Energy CS, Clean Tech and Valence Technology companies co-developed what is referred to as the E-Drive System, sometimes referred to as the “plug-in hybrid” system. In such a system, the hybrid vehicle can be plugged in and charged by a common three-prong, 110 volt home electrical outlet. This system provides long-range driving capabilities while minimizing gasoline usage and attendant emissions drawbacks. If sufficient electrical energy is stored in the hybrid car, the internal combustion engine can be temporarily shut off and the vehicle powered by the electrical energy alone.

The E-Drive System was developed to overcome the inherent limitations of hybrid vehicles to operate in full electric mode for substantial distances due to low state of charge (SOC) with the original equipment manufactured (OEM) battery pack. While the E-Drive System enables the hybrid vehicles to operate in full electric mode for greater distances, it also presents some drawbacks.

First, the E-Drive system obtains electricity from the wall outlet. This electricity is most likely derived from a coal or a natural gas power plant. Hence, the source of electricity is not “green”. Moreover, the hybrid vehicle owner must pay for the electricity drawn from the wall outlet to fuel the car batteries. Furthermore, additional or larger batteries are required to support the E-Drive System. Larger batteries increase vehicle cost and weight thereby negatively affecting efficiency.

Currently, several automakers produce hybrid powered vehicles, including Toyota, Honda, and Ford. Other automakers plan to enter this segment in the near future. Presently, Toyota leads the hybrid vehicle market with the Prius platform design that went to market in 2004. The Prius hybrid vehicle utilizes an internal combustion engine, a hybrid electrical propulsion system, a continuously variable transmission (CVT), regenerative braking systems, a 1.3 kilowatt-hour (kWh) NiMH battery pack and a 12 volt battery for basic vehicle functions, and several system controllers that utilize input information such as battery state of charge, road speed, accelerator pedal input, and load to determine how much electric energy is utilized compared to the internal combustion engine. A controller limits the factory battery system to a maximum of 200 watt-hours (Wh) of output before the internal combustion engine is started to supplement or fully power the hybrid vehicle. The 200 Wh is about 20% of the battery energy output. The system has limitations on how far the vehicle can drive in pure electric mode, thus limiting total fuel economy.

Accordingly, there is a need for a supplemental electric energy system for hybrid vehicles. Such an electric energy system should convert solar energy into electrical energy to supplement a hybrid vehicle battery pack. The present invention fulfills these needs and provides further related advantages.

### SUMMARY OF THE INVENTION

Herein disclosed is a solar energy system for a hybrid vehicle. The present invention is a clean, fully integrated solar charging system to supplement and charge a hybrid vehicle electrical system. Included in the solar energy system is a custom design low profile solar panel designed to be affixed to and fit along the contour of a hybrid vehicle roof by a panel attaching system. The solar panel efficiently develops sufficient low energy direct current (DC) electrical energy from sunlight. The low energy direct current electrical energy is transformed to high energy direct current through a DC to DC converter. The wiring harness, electrical connectors, and power converters provide a means for directing the harnessed low energy electrical energy and converted high energy electrical energy to desired locations throughout the hybrid vehicle electrical system. This high energy direct current is utilized as a supplemental energy source to charge the hybrid vehicle battery pack and supply energy to the other electrical components.

Electrical and mechanical subsystems control and monitor performance of the solar energy system of the present disclosure. The subsystems communicate with and augment the hybrid vehicle electrical system to ensure the system provides adequate renewal energy. The charge controller and system monitor ensure that the hybrid vehicle battery charge state operates at peak performance during daylight operation. The hybrid vehicle battery pack is energized both when in the hybrid vehicle is in operation an while parked. The solar energy system therefore does not require the extensive battery pack upgrade as required by the Toyota E-Drive system because the solar energy system provides continuous charge to vehicle components. The solar energy system as disclosed allows the hybrid vehicle to operate under typical driving conditions of thirty to fifty miles per day with maximum utilization of electric energy. Thus, the overall efficiency of the hybrid is increased.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a block diagram illustrating the basic energy flow of a solar energy system incorporated into a hybrid vehicle;

FIG. 2 is a diagrammatic cross-sectional view of a solar panel illustrating component layers thereof as used in accordance with a hybrid vehicle solar energy system;

FIG. 3 is a top view of a solar panel as used with a hybrid vehicle solar energy system;

FIG. 4 is a perspective view of a hard frame solar panel;

FIG. 5 is a perspective view of a flexible solar panel;

FIG. 6 is a top view of a solar panel configured to overly a hybrid vehicle roof having a hole for a satellite receiver;

FIG. 7 is a side view of the solar panel of FIG. 6, illustrating its contour to fit a hybrid vehicle roof; and

FIG. 8 is a perspective view of a DC to DC converter as integrated into a hybrid vehicle solar energy system.

### DETAILED DESCRIPTION OF THE PREFERRED EMBODIMENT

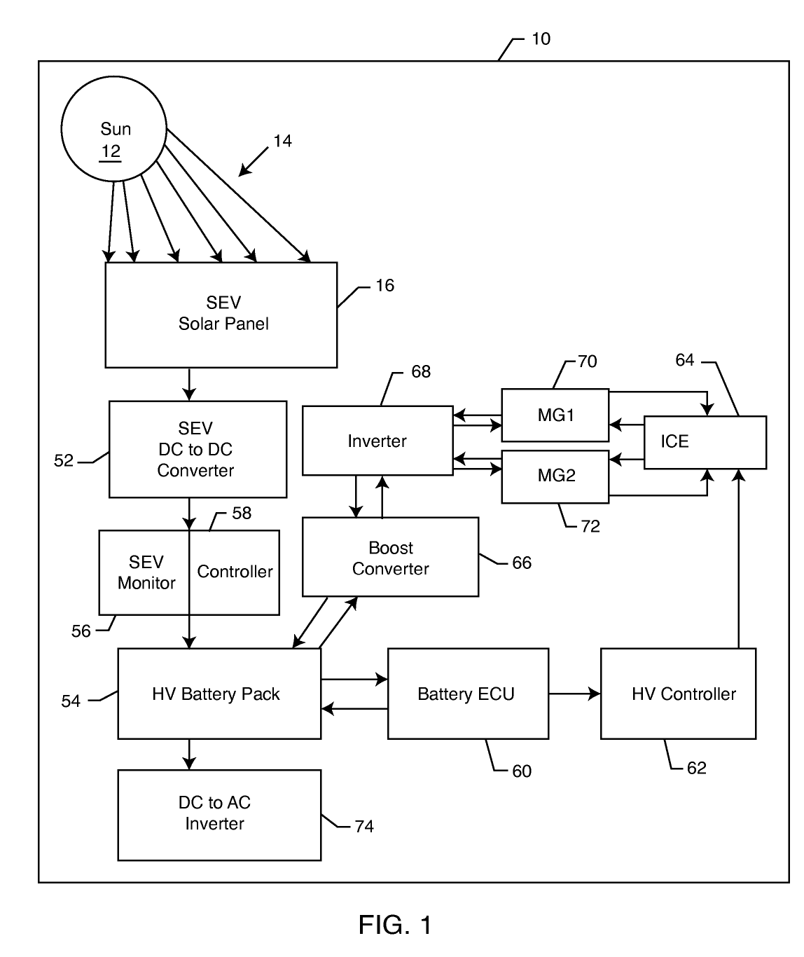

As shown in the exemplary drawings for purposes of illustration, the present disclosure for a solar energy system for a hybrid vehicle is referred to generally by the reference numeral 10. Turning now to the representative figures in the specification, FIG. 1 illustrates the basic energy flow of a solar energy system 10 as incorporated into the electrical system of a hybrid vehicle. In FIG. 1, a sun 12 irradiates sunlight 14 upon a solar panel 16. FIG. 7 shows the solar panel 16 sized and configured to overly a roof 18 of a hybrid vehicle 20 (FIG. 7). A person of ordinary skill in the art will readily recognize that the solar panel 16 could be configured to fit the roof 18 of vehicles having many different configurations. The hybrid vehicle 20 illustrated in FIG. 7 is merely a sample embodiment. The solar panel 16 could be utilized in vehicles that include, but not limited to, cars, trucks, sport utility vehicles, commercial vehicles, buses, and other vehicles having a roof or external structure. Furthermore, the solar panel 16 could be configured to fit to other parts of the hybrid vehicle 20, including the trunk, hood, doors, or other portion exposed to the sun 12.

Typically, the solar panel 16 is fixed to the roof 18 of the hybrid vehicle 20 in a permanent or semi-permanent manner. This includes double-sided foam adhesive tape, epoxy, adhesive fasteners, screws, or other adhesives or fasteners known in the art. The method and configuration for attaching the solar panel 16 to the hybrid vehicle 20 varies depending on the physical and operational characteristics of the hybrid vehicle 20. As previously disclosed, the solar panel 16 is capable of being utilized in a wide range of vehicles having an even greater range of applications and capabilities. Some applications may require a more durable solar panel, while other applications will require a more flexible solar panel, while still other applications will require a detachable solar panel.

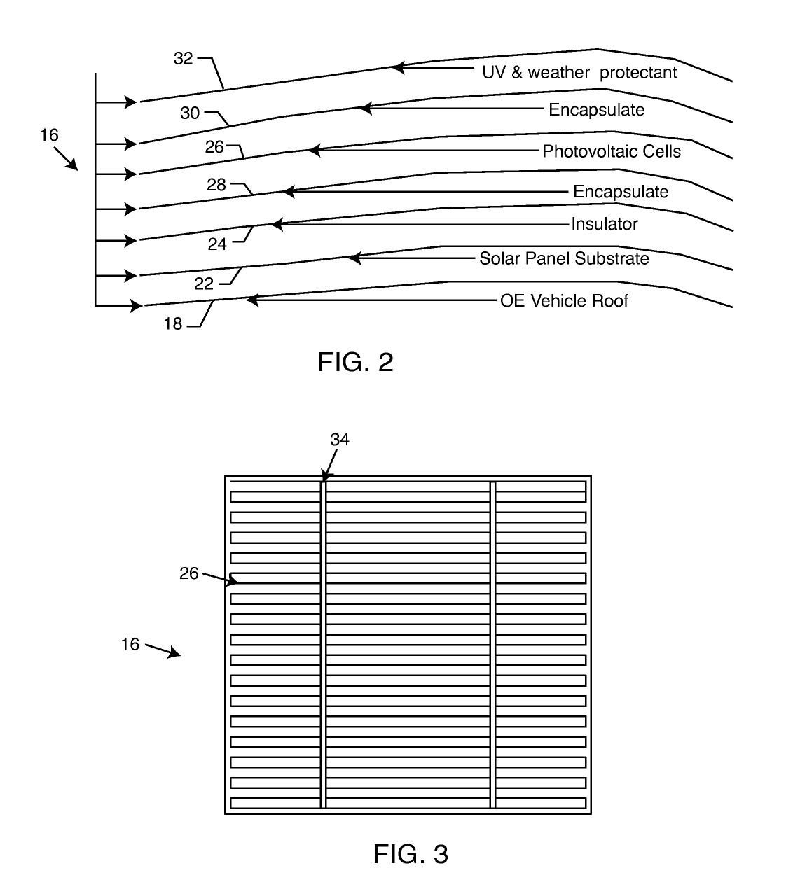

An enlarged side view of the solar panel 16 of the present disclosure is illustrated in FIG. 2. The solar panel 16 includes a lower substrate 22 which directly contacts the roof 18 of the hybrid vehicle 20. The connection methods described in the preceding paragraph are typically used to connect the lower substrate 22 to the roof 18 of the hybrid vehicle 20 as herein disclosed. Furthermore, the solar panel 16 may include an insulator layer 24, such as a substrate backed sheet panel insulator, to prevent energy leakage between the solar panel 16 and the roof 18 of the hybrid vehicle 20. The photovoltaic cells 26 are sandwiched between a first encapsulate layer 28 and a second encapsulate layer 30. The first encapsulate layer 28 and the second encapsulate layer 30 are utilized to seal the photovoltaic cells 26 from the environment and electrically insulate the individual photovoltaic cells 26 from one another. Additionally, the solar panel 16 may also incorporate an upper ultraviolet and weather protectant layer 32. The upper ultraviolet and weather protectant layer 32 can be applied using various methods, including, but not limited to, vacuum form, heat cured, or other means known in the art.

The lower substrate 22 of the solar panel 16 is molded from non-conductive materials such as fiberglass, fiberglass with Kevlar reinforcement, RFP plastic, carbon fiber, or any combination of these materials which provides the proper form and configuration to match the roof 18 or other external part of a hybrid vehicle. Accordingly, the remaining layers of the solar panel 16 conform to the configuration and shape of the lower substrate 22. Preferably, the solar panel 16 has a low profile form fitted component as illustrated in FIG. 7. Following the aerodynamic contour of the roof 18 prevents the solar panel 16 from negatively affecting the hybrid vehicle 20 profile.

As diagramed in FIG. 1, the solar panel 16 absorbs and transforms the sunlight 14 irradiated from the sun 12 to direct current electricity via a series of photovoltaic cells 26 shown in FIG. 3. It is appreciated by one of ordinary skill in the art that the photovoltaic cells 26 vary in quantity, cell size, energy output, color, and grid pattern design. These design variations allow for the development of solar panels having application specific energy outputs based on diverse vehicle roof construction. Hybrid vehicles having larger roofs and more of the photo voltaic cells 26 incorporated therein will derive increased solar energy output.

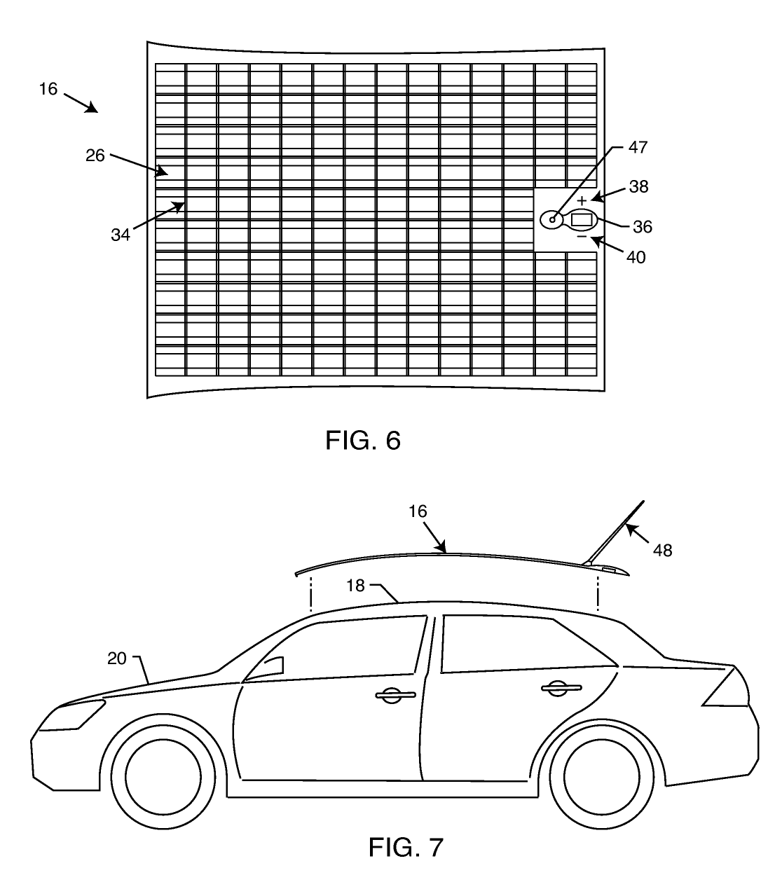

Typically, a series of connectors 34 formed from flat solder wire interconnect the photovoltaic cells 26 as described above. The connectors 34 run either in series or in parallel to generate a specific quantity of direct current electrical energy from the solar panel 16. The interconnected strings of the connectors 34 and the photovoltaic cells 26 all run into a master interconnect 36 (FIG. 6). The master interconnect 36 collects the voltage from the direct current electrical energy into a positive power output 38 and a negative power output 40 on the solar panel 16.

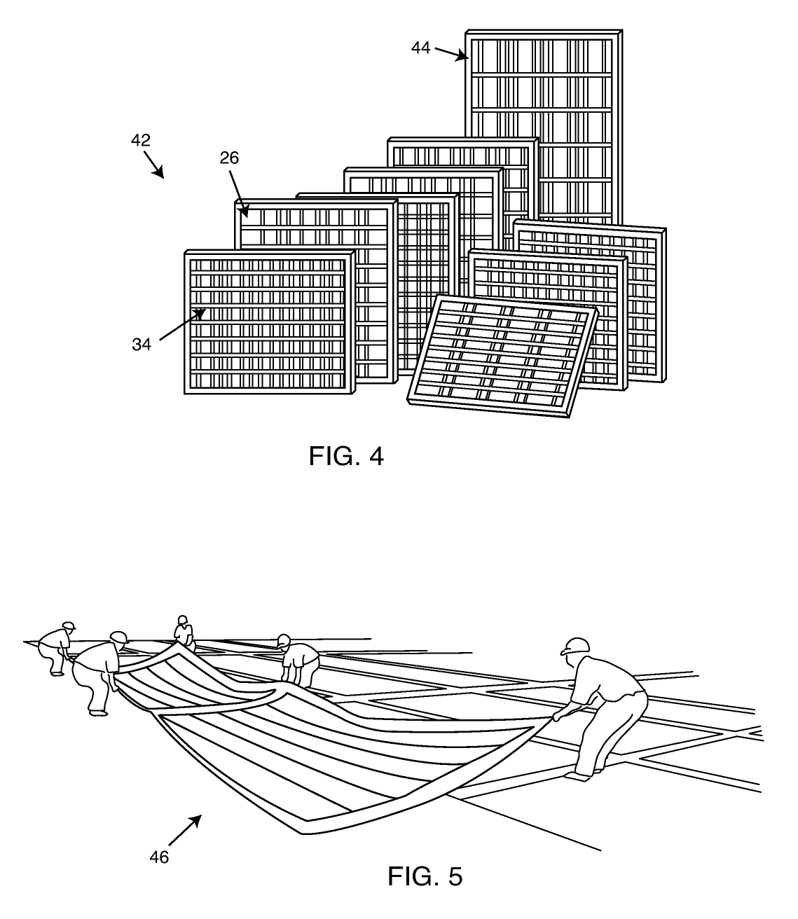

The solar panel 16 incorporating the photovoltaic cells 26 are manufactured in various sizes, shapes, and output power configurations. FIG. 4 illustrates a set of hard frame solar panels 42. The traditional hard frame solar panels 42 depicted in FIG. 4 have the photovoltaic cells 26 interconnected by the connectors 34 and protected from the environment by a glass sheet 44. The present disclosure conceives using the traditional hard frame solar panels 42 of FIG. 4 or, alternatively, a flexible solar panel 46 illustrated in FIGS. 5-7. In FIG. 6, the solar panel 16 includes an array of the photovoltaic cells 26 spread out in strings assembled into a power grid. Each assembled string produces direct current electricity. The grids are soldered together by the connectors 34 that lead to the master interconnect 36. In turn, the master interconnect 36 connects to the positive power output 38 and the negative power output 40. The solar panel 16 is configured to overlie the roof 18 of the hybrid vehicle 20 (FIG. 7) in width, length, and arcuate configuration. A gap or hole 47 (FIG. 7) in the solar panel 16 accommodates a protrusion 48 (FIG. 7) such as a radio antenna, cell phone antenna, or satellite receiver, or another roof feature such as a moon roof or sun roof, as incorporated into the hybrid vehicle 20. The solar panel 16 could also be modified to accommodate a variety of factory installed roof mount racks (not shown).

Turning back to the diagram in FIG. 1, the solar panel 16 collects solar energy during daylight hours from the sunlight 14 and converts this energy into low or moderate direct current electrical energy. The low or moderate direct current electrical energy is then transmitted via a wiring harness 50, located within the internal panels of the hybrid vehicle 20, to a DC to DC converter 52. The wiring harness 50 is application specific and designed for the efficient and safe transmission of direct current electrical energy as generated by the solar panel 16 and utilized to recharge a battery pack 54. The wiring harness 50 of adequate gauge and length is internally routed through electrical channels inside the hybrid vehicle panel walls. Furthermore, insulated connectors and fasteners (now shown) secure the wiring harness 50 to the hybrid vehicle 20 to prevent damage to the wiring harness 50 or the hybrid vehicle 20. The wiring harness 50 then supplies electricity to the necessary components of the solar energy system of the present disclosure.

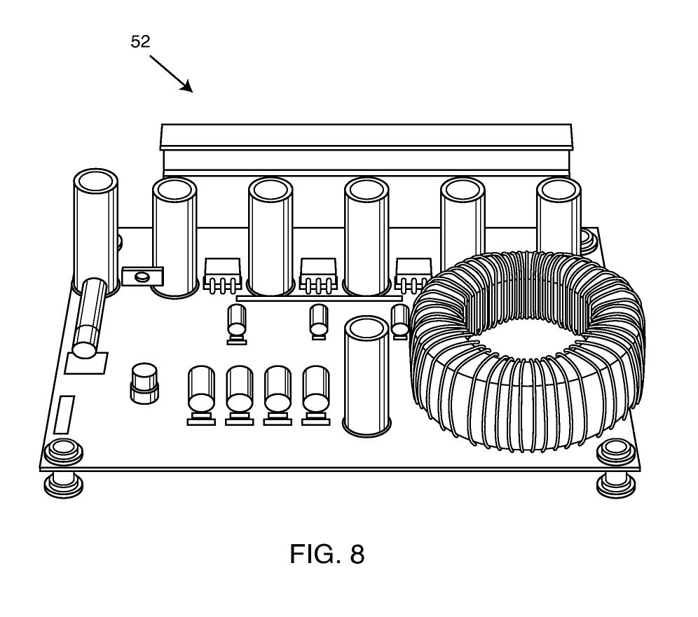

The wiring harness 50 transmits the low to moderate direct current electrical energy generated by the solar panel 16 to the converter 52 via the positive power output 38 and the negative power output 40 electrically connected to the photovoltaic cells 26 via the connectors 34 (FIG. 6). The converter 52 is designed to transform low to moderate energy direct current electricity to comparatively higher energy direct current electricity. This high energy direct current electricity is now of adequate voltage, wattage, and amperage to supply the electricity to the battery pack 54 and other hybrid vehicle electrical components. The converter 52 can vary in performance depending on the specific application needs and limitations of the hybrid vehicle solar energy system 10. For example, the converter 52 could convert approximately 70 volts of direct current electricity to over 200 volts of direct current electricity in order to charge the hybrid vehicle battery pack 54. Converters are well known in the art to step up electrical energy through wire winding and electronic components that function as controls to increase or limit converter output. The converter 52 recharges the battery pack 54 of the hybrid vehicle 20, regardless whether the battery pack 54 is a NiMH, lithium ion, lead acid, nickel metal hydride, or any combination thereof. A sample embodiment of the converter 52 is shown in FIG. 8.

Further disclosed in the solar energy system 10 of FIG. 1 are a set of subsystems that monitor and control the electrical performance of the present disclosure. Specifically, a monitor 56 monitors controls the electricity derived from the solar panel 16 and the converter 52 to prevent overcharging of the battery pack 54. The monitor 56 provides information detailing electrical system performance, state of charge for the battery pack, and voltage, wattage, or amperage use. More specifically, the monitor 56 could measure the solar panel 16 output in volts, amps, or watts.

Additionally, a controller 58 is provided as either integrated into the converter 52 or as a standalone unit. The controller 58 could be a proprietary hardware or software device that is designed to interface with the original hybrid vehicle control systems. Implementation of the controller 58 enables the hybrid vehicle 20 to utilize maximum, yet safe, levels of battery energy. Such utilization provides the capability to operate the hybrid vehicle 20 for extended time periods in electric mode. The controller 58 extends the battery pack 54 life by preventing overcharging while maintaining a peak charge. Either the monitor 56 or the controller 58 could incorporate an activation switch that notifies the hybrid vehicle operator that “electric only” mode is in current operation.

Additionally, the solar energy system 10 of the present disclosure could incorporate an additional optional battery pack (not shown) using NiMH, lithium ion, lead acid, nickel metal hydride, a comparable battery pack known in the art, or any combination of thereof. The additional battery pack upgrade provides additional battery energy to increase the overall watt hour (Wh) capacity of the solar energy system 10. Thus, the hybrid vehicle power train system efficiency increases and provides better fuel economy, longer operating range, and supplemented solar energy storage.

The remaining components of the present disclosure are further illustrated in the flowchart in FIG. 1. These components are typically part of a hybrid vehicle subassembly system and operational controls. Further provided is a battery pack electronic control unit (ECU) 60 that measures the temperature and voltage of the battery pack 54. The electronic control unit 60 controls the battery pack 54 charge state based on data collection readings and variable environmental conditions. The charge and discharge capacity of the battery pack 54 is precisely controlled to ensure safe and reliable driving.

Furthermore, a hybrid vehicle controller 62 interfaces with the electronic control unit 60 and an internal combustion engine 64 to provide display information and operating performance data to the hybrid vehicle operator. A boost converter 66 and an inverter 68, such as those used in the Toyota Synergy Drive System, convert direct current electrical energy from the battery pack 54 into alternating current electrical energy for use in a first motor generator 70 and a second motor generator 72. For example, in the Toyota Highlander hybrid vehicle, the first motor generator 70 starts the hybrid vehicle engine and charges the hybrid vehicle battery pack 54. The second motor generator 72 supplements the gasoline engine to provide additional front-wheel drive power.

Lastly, in a particularly preferred embodiment, the solar energy system 10 of the present disclosure integrates a direct current (DC) to alternating current (AC) inverter 74 (“DC to Ac inverter”) for converting the high energy direct current electricity in the battery pack 54 into household alternating current electricity. Here, the hybrid vehicle 20 acts as a power generator by supplying an uninterruptible source of power. The alternating current electricity generated by the DC to AC inverter 74 is linked to appropriate cords and plugs for use in a business or a residence. The power generator function of the hybrid vehicle 20 of the present disclosure is particularly useful during, for example, power outages and the like.

Although an embodiment has been described in detail for purposes of illustration, various modifications may be made without departing from the scope and spirit of the invention.

What is claimed is:

1. A solar energy system for a hybrid vehicle, comprising:
a solar panel attachable to the hybrid vehicle for receiving and converting solar energy into direct current electricity;
a converter for transforming direct current electricity from a comparatively lower energy state to a comparatively higher energy state;
a wiring harness electrically coupled to the solar panel, for directing the direct current electricity generated by the solar panel to the converter; and
a battery for receiving the high energy state direct current electricity from the converter as a supplemental energy source.

2. The solar energy system of claim 1, wherein the solar panel is aerodynamically shaped.

3. The solar energy system of claim 1, including an insulator for preventing energy loss between the solar panel and the hybrid vehicle.

4. The solar energy system of claim 1, wherein the solar panel includes an upper ultraviolet and weather protectant layer.

5. The solar energy system of claim 1, wherein the solar panel includes a plurality of photovoltaic cells.

6. The solar energy system of claim 5, wherein the photovoltaic cells are sandwiched between two encapsulant layers to environmentally seal and electrically insulate the photovoltaic cells from each other.

7. The solar energy system of claim 1, including a monitor for controlling information detailing the performance of the solar energy system.

8. The solar energy system of claim 7, wherein the monitor controls information detailing system performance, battery pack state of charge, and voltage, wattage or amperage use.

9. The solar energy system of claim 1, wherein the solar panel includes a flexible photovoltaic panel.

10. The solar energy system of claim 1, including an inverter for converting direct current electricity produced by the solar panel to alternating current electricity.

11. The solar energy system of claim 1, including a supplemental battery electrically coupled to the solar panel.

12. A solar energy system for a hybrid vehicle, comprising:
a solar panel attachable to the hybrid vehicle for receiving and converting solar energy into direct current electricity, wherein the solar panel includes an upper ultraviolet and weather protectant layer;
a converter for transforming direct current electricity from a comparatively lower energy state to a comparatively higher energy state;
a wiring harness electrically coupled to the solar panel, for directing the direct current electricity generated by the solar panel to the converter;
a battery for receiving the high energy state direct current electricity from the converter as a supplemental energy source; and
a monitor for controlling information detailing the performance of the solar energy system.

13. The solar energy system of claim 12, including an insulator for preventing energy loss between the solar panel and the hybrid vehicle, wherein the solar panel is aerodynamically shaped.

14. The solar energy system of claim 12, wherein the solar panel includes a plurality of photovoltaic cells sandwiched between two encapsulant layers to environmentally seal and electrically insulate the photovoltaic cells from each other.

15. The solar energy system of claim 12, wherein the monitor controls information detailing system performance, battery pack state of charge, and voltage, wattage or amperage use.

16. The solar energy system of claim 12, wherein the solar panel includes a flexible photovoltaic panel.

17. The solar energy system of claim 12, including an inverter for converting direct current electricity produced by the solar panel to alternating current electricity.

18. The solar energy system of claim 12, including a supplemental battery electrically coupled to the solar panel.

19. A process for utilizing solar energy in a hybrid vehicle, comprising the steps of:
converting solar energy to direct current electricity through a photovoltaic cell of a solar panel disposed on an exterior of the hybrid vehicle;
transmitting the direct current electricity from the solar panel to a converter electrically coupled to the solar panel;
transforming the direct current electricity from a comparatively lower energy state to a comparatively higher energy state; and
supplementing the hybrid vehicle battery with the higher energy state direct current electricity from the converter.

20. The process of claim 12, including the step of charging the hybrid vehicle battery with the direct current electricity from the converter.

21. The process of claim 12, including the steps of monitoring and controlling information detailing the utilization of solar energy by the hybrid vehicle.

22. The process of claim 14, including the step of controlling the state of charge of the battery and solar panel output.

23. The process of claim 14, including the step of regulating battery energy levels.

24. The process of claim 14, including the step of monitoring information detailing voltage, wattage or amperage use with the monitor.

25. The process of claim 12, including the step of converting direct current electricity to alternating current electricity.

26. The process of claim 17, including the step of generating an uninterruptible source of alternating current electricity such that the hybrid vehicle acts as a power generator.

27. The process of claim 12, including the step of collecting direct current electricity from the photovoltaic cell of the solar panel via a master transmitter electrically coupled to the solar panel and the converter.

28. The process of claim 12, including the step of distributing a plurality of photovoltaic cells throughout the solar panel.

29. The process of claim 12, including the step of conforming the solar panel to fit the contour of a hybrid vehicle roof.

30. The process of claim 12, including the step of connecting a removable solar panel to an exterior surface of the hybrid vehicle.

31. The process of claim 12, including the step of monitoring information detailing system performance, battery state of charge.

32. A process for utilizing solar energy in a hybrid vehicle, comprising the steps of:
converting solar energy to direct current electricity through a photovoltaic cell of a solar panel disposed on an exterior of the hybrid vehicle;
transmitting the direct current electricity from the solar panel to a converter electrically coupled to the solar panel;
transforming the direct current electricity from a comparatively lower energy state to a comparatively higher energy state;
supplementing the hybrid vehicle battery with the higher energy state direct current electricity from the converter;
monitoring and controlling information detailing the utilization of solar energy by the hybrid vehicle; and
distributing a plurality of photovoltaic cells throughout the solar panel.

33. The process of claim 32, including the step of charging the hybrid vehicle battery with the direct current electricity from the converter.

34. The process of claim 32, including the steps of:
controlling the state of charge of the battery and solar panel output;
regulating battery energy levels;
monitoring information detailing voltage, wattage or amperage use with the monitor; and
converting direct current electricity to alternating current electricity.

35. The process of claim 32, including the steps of:
generating an uninterruptible source of alternating current electricity such that the hybrid vehicle acts as a power generator; and
collecting direct current electricity from the photovoltaic cell of the solar panel via a master transmitter electrically coupled to the solar panel and the converter.

36. The process of claim 32, including the steps of:
conforming the solar panel to fit the contour of a hybrid vehicle roof;
connecting a removable solar panel to an exterior surface of the hybrid vehicle; and
monitoring information detailing system performance, battery state of charge.
